(19) United States
(12) Patent Application Publication
(10) Pub. No.: US 2014/0033475 A1
(43) Pub. Date: Feb. 6, 2014

(54) ASSIST DEVICE FOR MOVABLE BODY

(71) Applicant: Norio Saito, Fujisawa-shi (JP)

(72) Inventor: Norio Saito, Fujisawa-shi (JP)

(73) Assignee: NIFCO INC., Yokohama-shi, Kanagawa (JP)

(21) Appl. No.: 14/004,806

(22) PCT Filed: Mar. 13, 2012
(86) PCT No.: PCT/JP2012/056457

§ 371 Date: Oct. 7, 2013

(30) Foreign Application Priority Data
Mar. 14, 2011 (JP) 2011-055898
Oct. 31, 2011 (JP) 2011-238531

(51) Int. Cl. E05F 1/16; E05F 3/10; E05F 3/02

(52) U.S. Cl. CPC E05F 1/16; E05F 3/02; E05F 3/10
USPC 16/49; 16/71; 16/76

(57) ABSTRACT

A movable body assisting apparatus according to an embodiment includes a received body provided on either one of a support body and a movable body that moves relatively against the support body; and a base body. A contact body is provided to be capable of coupling and uncoupling with the received body, to be capable of moving along a course of movement from a first position to a second position on the base body, and to be capable of rocking while moving in a direction retreating from the course of movement. An urging mechanism for urging the contact body is provided on the other of the support body and the movable body.

### TECHNICAL FIELD

The present invention relates to a movable body assisting apparatus for assisting movement of various kinds of movable bodies.

### BACKGROUND TECHNOLOGY

There is known a movable body assisting apparatus in which forcible movement is effected using an urging mechanism in order to assist movement of a sliding door or other movable body. In such a movable body assisting apparatus, a received body is provided on the side of the door frame, and a contact body capable of coupling with the received body is provided on the side of the sliding door. The contact body is capable of sliding between a standby position and a drawn-in position, and is connected to a tension coil spring as the urging mechanism. The contact body, for example, has a coupling part made of resin on a leading end, and this coupling part is capable of coupling and uncoupling with the received body.

When the sliding door is in an open position not being completely closed, the contact body is held in the standby position in a state in which the tension coil spring is most stretched. When an operator moves the sliding door to the closed position from the open position, the contact body collides with the received body in midcourse, and captures the received body. At the same time, the holding in the standby position is released, and the contact body is drawn by the tension coil spring and moves toward the drawn-in position while having captured the received body. Therefore, the sliding door is moved forcibly in an amount corresponding to the dimension of this movement.

When the sliding door is in the closed position, the contact body is in a state in which the tension coil spring is compressed. When the operator moves the sliding door toward the open position from the closed position, the sliding door moves while drawing the tension coil spring. The contact body releases the received body upon reaching a prescribed position, and is again held in the standby position.

The movable body assisting apparatus may become in a state in which the contact body is in the drawn-in position while the contact body is not coupled to the received body. As a mechanism for returning from this state, a diagonal guide surface may be provided on the contact body so that the received body and the contact body may be coupled by rotating to apply pressure downward to retreat from the received body by contact with the received body (see, for example, Patent Document 1). In this assisting apparatus, the contact body is configured in a prescribed shape so as to couple again to the received body by rotating around a shaft, and is formed so that a frame body having received the contact body is elastically deformed downward, and a gap allowing deformation of the frame body is provided.

### PRIOR ART DOCUMENTS

### Patent Documents

Patent Document 1: Japanese Unexamined Patent Publication No. 2006-169723

### SUMMARY OF THE INVENTION

### Problem to be Solved by the Invention

There is a problem as follows in the technology described above. Specifically, the abovementioned technology has a configuration in which the contact body is rotated with a shaft in a fixed state, and complex dimensional settings become necessary accompanying deformation of the parts.

Therefore, an object of the present invention is to provide a movable body assisting apparatus in which return from a malfunctioning state is made possible with a simple configuration and breakage of parts can be avoided.

### Means for Solving the Problem

The movable body assisting apparatus according to the present invention comprises: a received body provided on either one of a support body and a movable body that moves relatively against the support body; and a base body, a contact body provided to be capable of coupling and uncoupling with the received body, to be capable of moving along a course of movement from a first position to a second position on the base body, and to be capable of rocking while moving in a direction retreating from the course of movement, and an urging mechanism for urging the contact body, provided on the other of the support body and the movable body.

### EFFECT OF THE INVENTION

According to the present invention, return from a malfunctioning state is made possible and breakage of parts can be avoided.

### BRIEF DESCRIPTION OF THE DRAWINGS

FIG. 1 is an explanatory diagram illustrating the movement of a sliding door provided with an assisting apparatus according to one embodiment of the present invention.

FIG. 2 is an explanatory diagram illustrating the movement of a sliding door provided with the assisting apparatus according to the same embodiment.

FIG. 3 is a perspective view of the assisting unit according to the same embodiment.

FIG. 4 is a perspective view of the striker according to the same embodiment.

FIG. 5 is a side view of the assisting apparatus according to the same embodiment.

FIG. 6 is a plan view of the assisting unit according to the same embodiment.

FIGS. 7a, 7b, 7c and 7d are explanatory diagrams illustrating the normal movement of the assisting apparatus according to the same embodiment.

FIGS. 8a, 8b, 8c and 8d are explanatory diagrams illustrating the movement during malfunction of the assisting apparatus according to the same embodiment.

FIG. 9 is a perspective view of the assisting apparatus according to a second embodiment.

FIG. 10 is a side view of the same assisting embodiment.

FIGS. 11a and 11b are explanatory diagrams illustrating the normal movement of the same second embodiment.

FIGS. 12a, 12b, and 12c are explanatory diagrams illustrating the movement during malfunction of the same second embodiment.

### EMBODIMENTS OF THE INVENTION

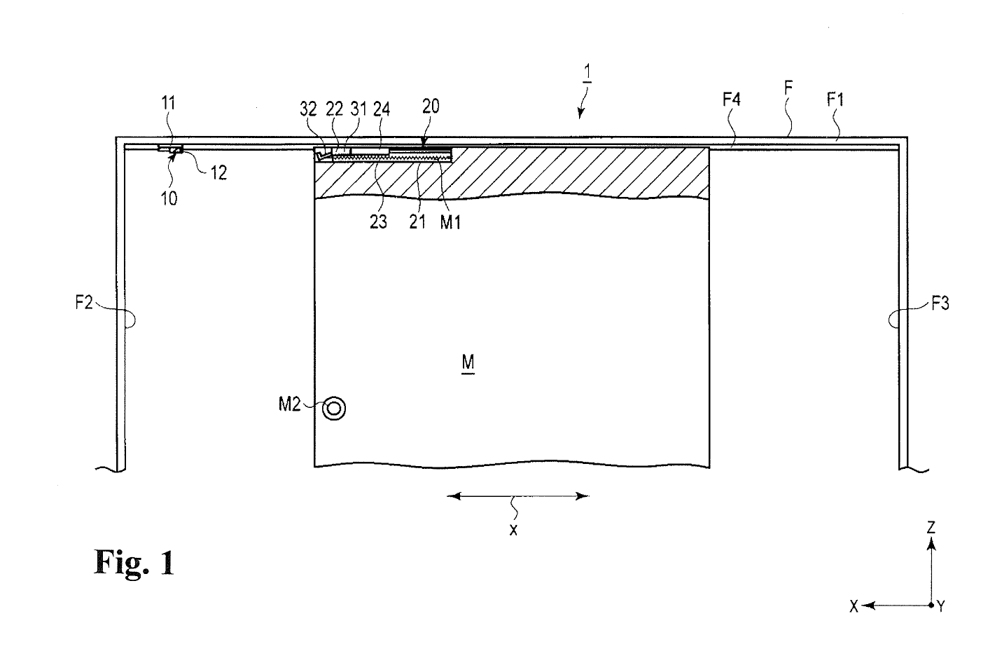

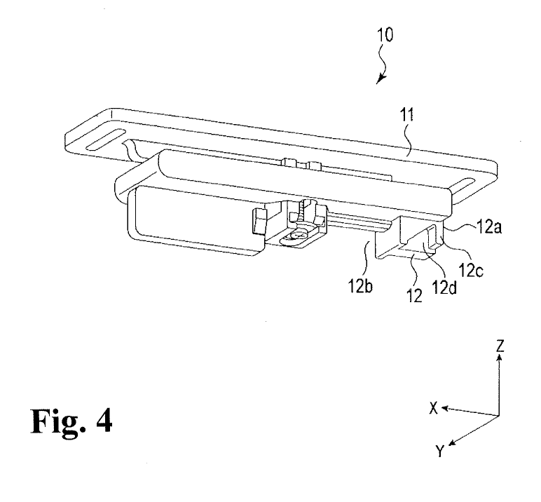

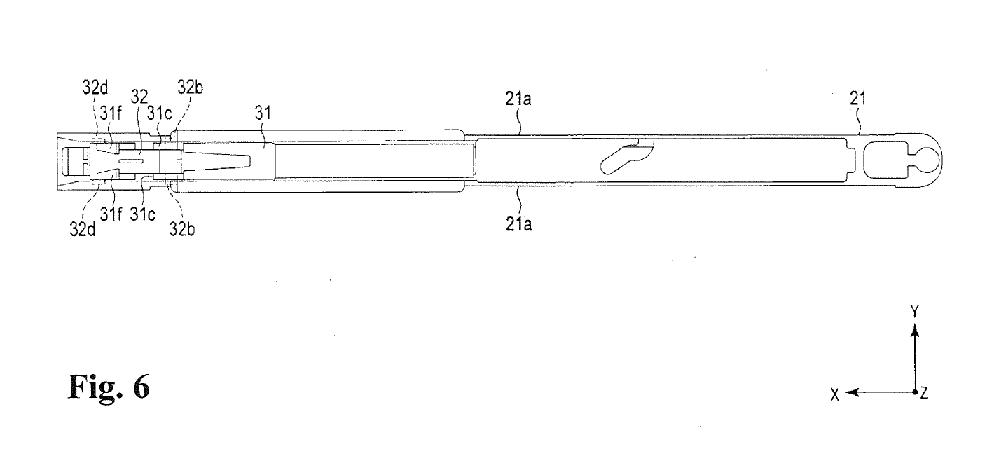

A movable body assisting apparatus 1 according to the embodiment of the present invention is described below while referring to FIGS. 1 through 8d. The arrows, X, Y, and Z, in the drawing respectively indicate three orthogonal directions. Here, for example, the X axis follows the sliding direction, the Y axis follows the width direction, and the Z axis follows the vertical direction. Also, suitable configurations are illustrated enlarged or reduced or are omitted for the purpose of description in each drawing.

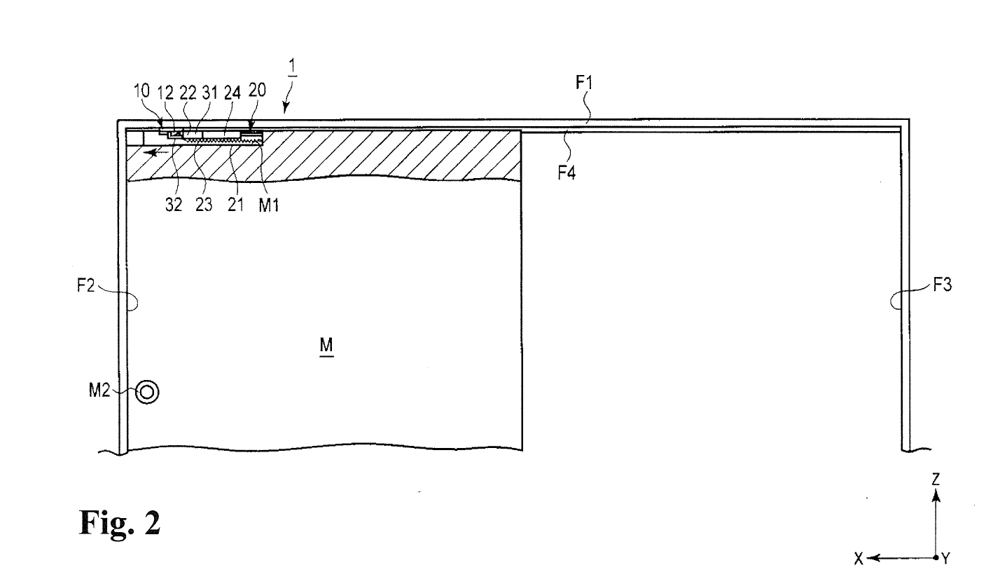

As illustrated in FIGS. 1 and 2, the assisting apparatus 1 is configured with a striker 10 as a received body provided on one of a movable body and a support body, and an assisting unit 20 provided on the other of the movable body and the support body.

In the present embodiment, for example, the support body is a door frame F, the movable body is a sliding door M, the assisting unit 20 is provided on the sliding door as the movable body, and the striker 10 is provided on the door frame F as the support body.

As illustrated in FIG. 1, the sliding door F has an upper frame F1, a left frame F2, a right frame F3, and a lower frame. A sliding door groove F4 following the sliding direction is formed on the upper frame F1, and the sliding door M is received to be capable of sliding in the sliding door groove F4.

A groove M1 for receiving the assisting unit 20 is formed following the sliding direction on the upper end part of the sliding door M. Here, the focus is on a single sliding door M, and the left side is the leading side of the door and the right side is the trailing side of the door. A knob M2 is formed on the left end part, as the leading side, of the sliding door M.

The open state, in which the sliding door M is not in contact with the left frame F2 as illustrated in FIG. 1, is referred to as the “first state,” and the closed state, in which the sliding door is moved completely to the position at the end of movement on the leading side of the door as illustrated in FIG. 2, is referred to as the “second state.”

The assisting apparatus 1 has a striker 10 provided on the door frame F and an assisting unit 20 provided on the sliding door M.

The assisting unit 20 has a housing 21 as the base body provided in the groove M1 on the upper end part of the sliding door M; a latch 22 received on an end part on one side (the left side in FIG. 1) in the sliding direction of the housing 21 and supported to be capable of sliding between a standby position and a drawn-in position; an urging mechanism 23 for urging the latch 22 to the other side (the right side in FIG. 1) in the sliding direction on the housing; and a damping mechanism 24 connected to the latch 22 and used for applying a resistance force to buffer the sliding movement of the latch 22.

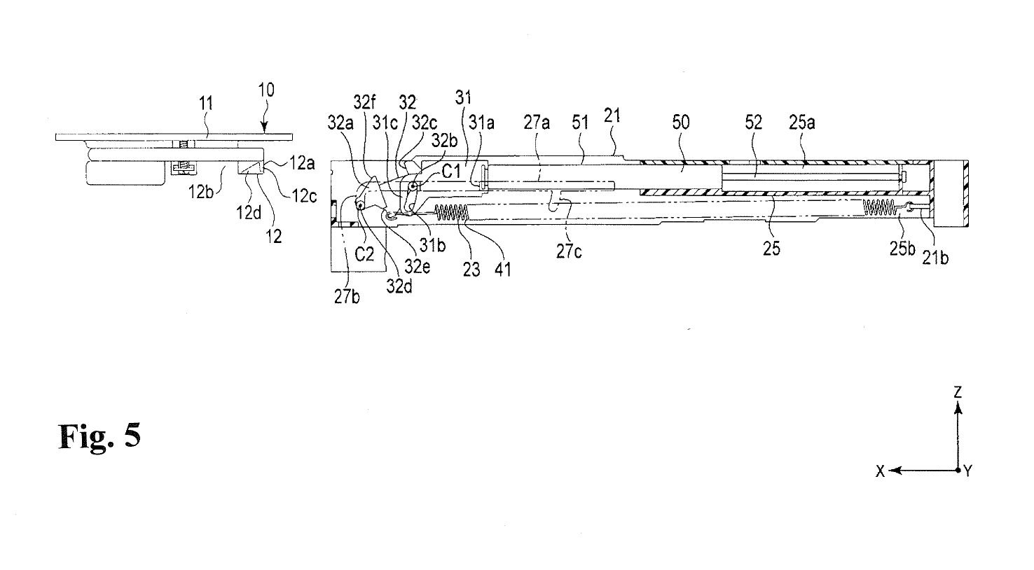

A striker 10 is provided at a fixed position from the left end in the sliding door groove F4 on the upper end of the door frame F. As illustrated in FIG. 5, the striker 10 is configured such that a plate-form installation member is installed on the upper frame F1; and a coupling projection 12 has a surface orthogonal to the Y axis and projecting downward from the upper frame F1. By movement of the sliding door, the coupling projection 12 couples to the latch 22 through the groove M1 on the upper part of the sliding door M and enters into the assisting unit 20, or comes out from the assisting unit 20 and is released. The end face of the coupling projection 12 forms a pressing surface 12a for pressing a pressed part 32c, and a first coupling recess 12b (first coupling part) receding upward is formed on one end side in the X direction of the coupling projection 12. A coupling claw 12c projecting in the Y direction is formed on the end part of the coupling projection 12. A triangular second coupling recess 12d (second coupling part) receding upward on both ends in the Y direction is formed on the side behind the coupling claw 12c. The second coupling recess 12d is disposed further toward the other end side (the right side in FIG. 5) than the first coupling recess 12b.

During the first movement and the second movement when normal, the hook part 32f of the latch 22 advances into the first coupling recess 12b, and the coupling projection 12 is captured by the catcher 32. Also, during the third movement when returning from malfunction, a pair of thin plate-form hook parts 32f advances into both sides in the Y direction of the latch 22, and the coupling claw 12c is captured by the catcher 32. The striker 10 couples to the latch 22 by these couplings so as to move as one body.

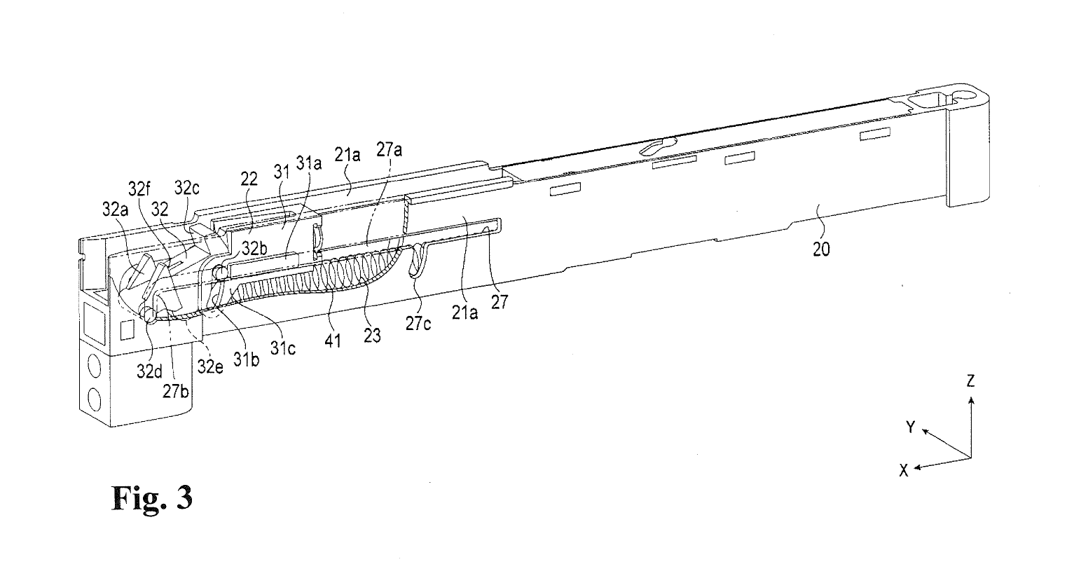

As illustrated in FIGS. 3, 5, and 6, the housing 21 has a long and slender box form in the sliding direction with the upper face open. In the rear portion of the housing 21, a partitioning plate 25 is provided in the center in the Z direction, and an upper chamber 25a on the upper side and a lower chamber 25b on the lower side are formed. One end side of the upper chamber 25a is open so that a latch base 31 is received between side walls 21a and 21a sandwiching the upper chamber 25a. In FIGS. 3 and 5, a portion of the housing 21 is cut open and illustrated in cross section for description of the internal structure.

A slit 27 is provided on one end side of each of the side walls 21a and 21a of the housing 21. This slit 27 has a shape having continuously a main guide path 27 extending from the standby position (first position) to the drawn-in position (second position) following the X direction; a standby path 27b curving from the standby position on the front end part of the main guide path 27a and extending downward; and a retreat path 27c branching from the drawn-in position at the rear portion of the main guide path 27a and extending to curve in an arc form downward and forward. The retreat path 27c forms an arc form around a second shaft part during retreating movement.

A second shaft part 32d formed on the front end part of the latch 22 is coupled to be capable of rotation in the slit 27. Also, a first shaft part 32b is coupled to be capable of rotation and to be capable of moving sliding at a position further rearward from the second shaft part 32d in the slit 27. Furthermore, a projecting part 31a of the latch base 31 is coupled to be capable of sliding on the main guide path 27a of the slit 27.

A connection part 21b for anchoring an end part of a tension coil spring 41 to the housing 21 is formed inside the lower chamber 25b of the housing 21. The connection part 21b, for example, is a shaft-form member spanning between the side walls 21a and 21a, and the other end side of the tension coil spring 41 is attached to the connection part 21b.

As illustrated in FIGS. 3, 5, and 6, the latch 22 has a latch base 31 and a cam part 32 connected to be capable of rotation on the leading end part of the latch base 31, and is supported to be capable of movement between the side walls 21a and 21a inside the housing 21.

The latch base 31 has a projecting part 31a formed long and slender in the X direction. The latch base 31 is held to be capable of sliding between the pair of side walls 21a and 21a forming the upper chamber 25a of the housing 21, by coupling of the projecting part 31a into the slit 27. A support piece 31c having an arc-form groove 31b following the retreat path 27c is provided on the leading end part of the latch base 31.

The cam part 32 has an axial center C1 following the Y direction, and a pair of first shaft parts 32b projecting in the Y direction. The first shaft part 32b is inserted through the slit 27 and the groove 31b and is coupled to be capable of rotation and to be capable of moving inside the slit 27.

The cam part 32 is provided to be capable of rotation in a first rotational direction R1 and in an opposite second rotational direction R2 around the first shaft part 32b. The cam part 32 is configured with a catcher 32a, a pressed part 32c, an impelled part 32e, and a pair of second shaft parts 32d, in this order clockwise on the outer perimeter part thereof.

The catcher 32a is provided on the leading end side of the cam part 32, and has a pair of hook parts 32f projecting in the R1 direction. The hook parts 32f are provided respectively on both sides in the Y direction, and include a triangular plate-form member.

The pressed part 32c is formed to project upward on the upper part of the cam part 32, and contacts with the contact surface 12a of the striker 10 and is pressed in the drawing-in direction by movement of the movable body.

The pair of second shaft parts 32d is formed on the catcher 32a, has an axial center C2 following the Y direction, is formed to project in the Y direction, and is coupled to be capable of moving inside the slit 27.

The impelled part 32e is provided on the lower part of the cam part 32, and is positioned further rearward and downward from the second shaft part 32d. The impelled part 32c is disposed on the lower part of the housing 21, and is connected with one end 41a of the tension coil spring 41. The impelled part 32e is normally drawn in the drawing-in direction by the tension coil spring 41.

The urging mechanism 23 is formed with the tension coil spring 41 as first urging means. The tension coil spring 41 is disposed in the lower part of the housing 21 so that the axial direction follows the sliding direction. One end of the tension coil spring 41 is connected to the impelled part 32e on the lower part of the latch 22, and the other end is connected to the connection part 21b of the housing 21. The tension coil spring 41 has a function of urging the latch 22 in the standby state in the drawing-in direction and thereby hanging and holding the latch on the standby path 27b, a function of urging and forcibly moving the latch 22 on the main guide path 27a in the drawing-in direction, and a function of urging the latch 22 in the R2 direction.

The damping mechanism 24 is formed with a piston damper 50 provided inside the upper chamber 25a of the housing 21. The piston damper 50 has a cylinder 51 having a fluid sealed inside; a piston that moves reciprocating on the sliding axis X of the latch 22 inside the cylinder 51, and a piston rod 52 connected to the piston.

The end part of the piston rod 52 is fixed to the housing 21, and the outside end part of the cylinder 51 opposite the piston is connected to the rear end of the latch 22.

The damping mechanism 24 applies fluid resistance of the fluid inside the cylinder 51 to the movement of the piston received inside the cylinder 51, and thereby applies the resistance force to the pushing-in and pulling-out movement of the cylinder 51 or piston 52 and damps the sliding movement of the latch 22 against the housing 21. Typically, silicon oil or another viscous fluid is used as the fluid sealed inside the cylinder 51, but the present invention is not limited to this, and a gas also may be used.

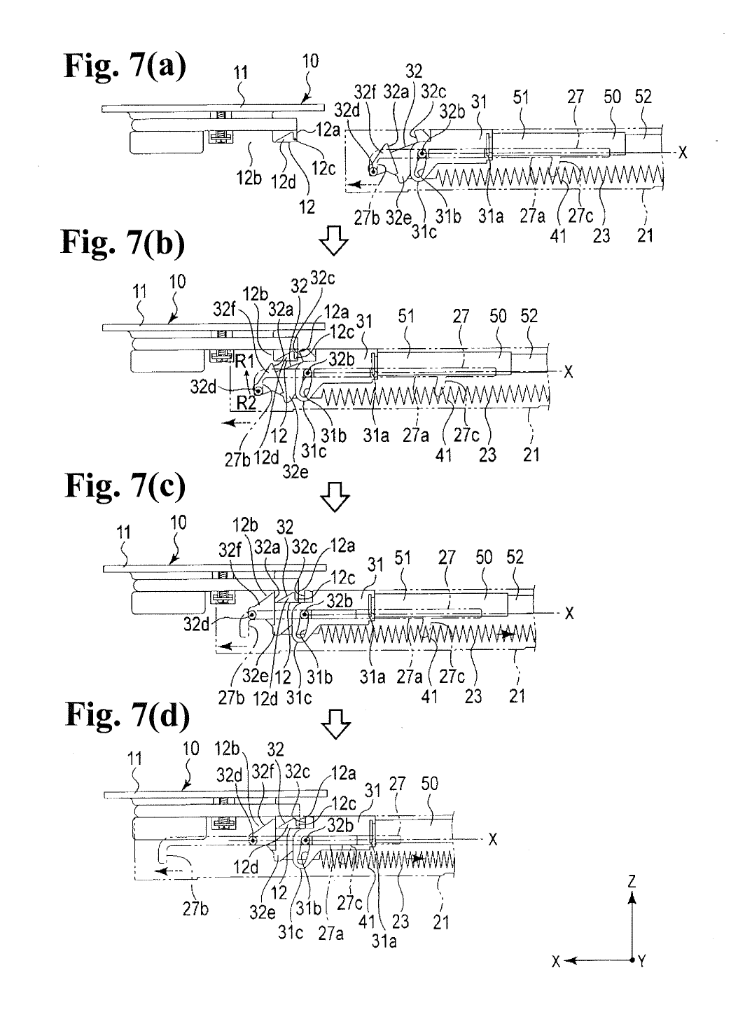

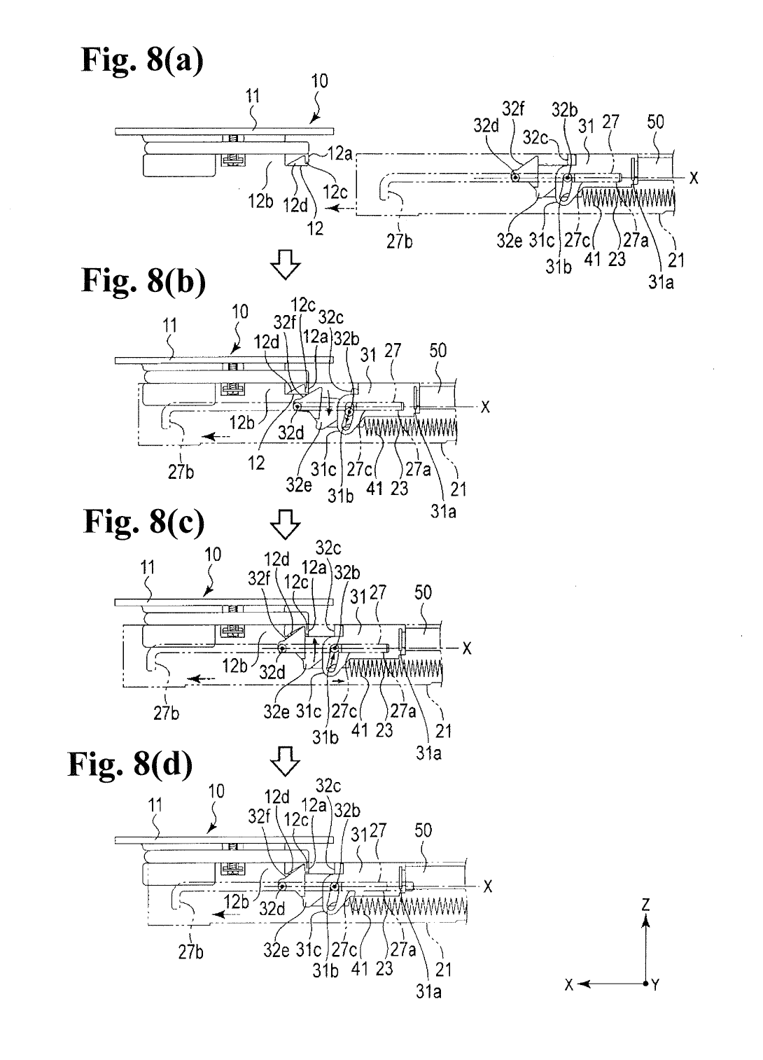

The movement of the assisting apparatus 1 according to the present embodiment is described in below while referring to FIGS. 7a, 7b, 7c, and 7d, and FIGS. 8a, 8b, 8c, and 8d.

As illustrated in FIGS. 1 and 7a, in the first state in which the sliding door M has not reached the striker 10, the second shaft part 32d of the latch 22 is hung on the standby path 27b and is drawn by the tension coil spring 41 and thereby held, and the latch 22 is held in the standby position on the end part of the housing 21.

A first movement from the first state to the second state is described. An operator moves the sliding door M toward the doorstop F1 on the left side from the first state, whereby the latch 22 contacts with the striker 10 when the sliding door reaches a first prescribed position as illustrated in FIG. 7b. Then, the striker 10 pushes the pressed part 32c in rearward, whereby the cam part 32 rotates in the R1 direction around the first shaft part 32b.

By this rotation, as illustrated in FIG. 7c, the hook part 32f on the leading end of the cam part 32 couples to the striker 10, and the striker 10 is captured by the latch 22. Also, the cam part 32 rotates in the R1 direction, and at the same time, the second shaft part 32d, being down, moves upward and reaches a position to enter into the main guide path 27a, the hold to the standby path 27b is released, and it comes to a state in which movement is possible following the sliding axis X, which is the center line of the main guide path 27a.

Also, as illustrated in FIG. 7d, the latch 22 moves relatively rightward against the housing 21 and the sliding door M and is moved relatively up to the drawn-in position by the return force of the tension coil spring 41. The sliding door M and the housing 21 are forcibly moved relatively to one end side in the sliding direction against the support body F and the striker 10 accompanying this movement. At this time, resistance force is applied by the damping mechanism 24, and the sliding door M moves in the closing direction automatically and gently while being buffered.

A second movement from the second state to the first state illustrated in FIGS. 2 and 7d is next described. In this second movement, the movement is in the order of FIGS. 7d, 7c, 7b, and 7a, which is the reverse of the abovementioned first movement. When the sliding door M is operated to be moved to the right side from the second state in which the sliding door M was moved completely up to the end position at the left side, the sliding door M moves to the right side while the latch 22 in a state having captured the striker 10 moves relatively to one end side against the sliding door M and the housing 21 in opposition to the urging force of the tension coil spring 41 (FIG. 7c). At this time, because the rear end of the latch 22 is connected to the piston rod 52 of the piston damper 50, resistance force of the fluid inside the cylinder 51 is received while the piston is moved.

When the sliding door reaches the prescribed position, as illustrated in FIG. 7b, the striker 10 is removed from the pressed part 10 and the cam part 32 rotates in the R2 direction centered on the first shaft part 32b by the return force of the tension coil spring 41. The hook part 32f comes out from the coupling recess 13b and the coupling with the striker 10 is released by this rotation. At the same time, the second shaft part 32d reaches the standby position at the front end of the main guide path 27a, the second shaft part 32d enters into the standby path 27b below and the latch returns to the standby state being held again in the standby position by the tension coil spring 41. After that, the movement of the sliding door M is released from the urging force of the tension coil spring 41. Also, the striker 10 is released and the first state in FIG. 7a is restored.

A third movement, for example, a return movement from a third state in which the latch 22 was moved to the drawn-in position without being coupled to the striker 10 due to malfunctioning, or the like, is next described.

When the sliding door M is moved in the first direction against the support body from a third state in which the latch is in the drawn-in position in a state in which the coupling with the striker 10 was released as illustrated in FIG. 8a, a part (here, hook part 320 of the cam part 32 contacts with the striker 10 and is pressed rearward as illustrated in FIG. 8b. By this pressing, the cam part 32 rocks while rotating in the R1 direction around the second shaft part 32d while the first shaft part 32b moves downward along the retreat path 27c. By this rocking, the upper end of the hook part 32f of the catcher 32a retreats further downward from the second state, whereby the striker 10 becomes capable of riding over the hook part 32f, moves along the X direction, and thereby becomes capable of moving in the drawing-in direction up to a position to be capable of coupling to the latch 22.

As illustrated in FIG. 8c, when the claw part 12c of the striker 10 rides over the hook part 32f, the cam part 32 rotates in the R2 direction by the return force of the tension coil spring 41, and the hook part 32f is inserted into the coupling recess 12d, whereby the latch 22 couples with the striker 10. When the sliding door M is moved in the second direction (direction moving away from the position at end of movement) in this coupled state, as illustrated in FIG. 8d, the movement follows the main guide path 27a in a state in which the striker 10 is captured by the latch 22. Also, when the sliding door reaches the prescribed position, the coupling between the contact body and the received body is released, and the first state in which the contact body is held in the standby position is restored.

According to the present embodiment, return from a malfunctioning state is made possible and breakage of parts can be avoided. Specifically, return from the third state to the first state is made possible by rocking of the latch 22 while retreating from the sliding axis X being the center line of movement. Also, the allowable range of the height dimension is increased and dimensional setting is easier by configuring so that the latch 22 rocks while moving downward. Also, collision between the striker 10 and the latch 22 is prevented by this retreat and breakage can be avoided. Also, because there is no need to elastically deform parts during automatic return, breakage of parts due to elastic resin fatigue, or the like, can be prevented and long-term performance can be maintained.

Furthermore, according to the present embodiment, a plurality of different movement can be performed with a simple configuration in which the latch 22 is provided with a biaxial structure and only moves inside one slit 27.

Also, the tension coil spring 41 can perform a plurality of different functions with a simple configuration, having a function of urging the latch 22 in the standby state in the drawing-in direction and thereby hanging and holding the latch on the standby path 27b, a function of urging and forcibly moving the latch 22 on the main guide path 27a in the drawing-in direction, and a function of urging the latch 22 in the R2 direction.

### Second Embodiment

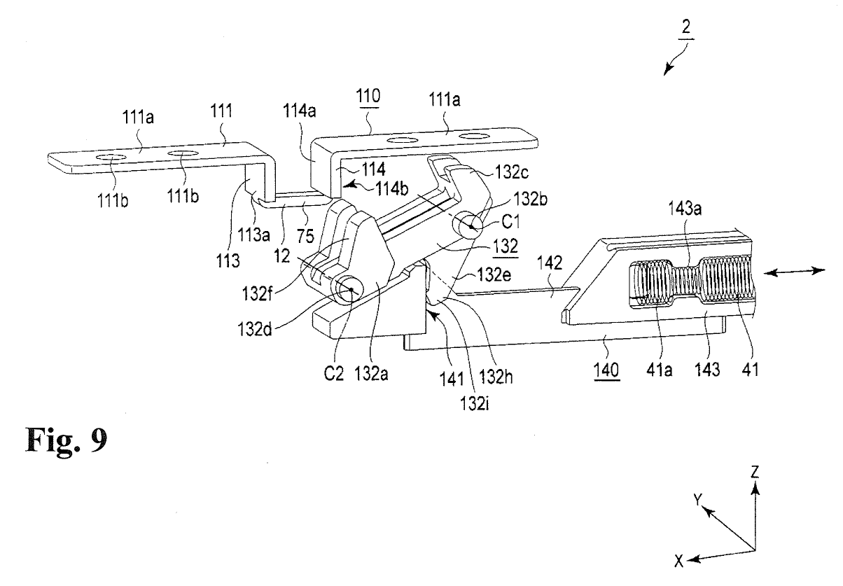

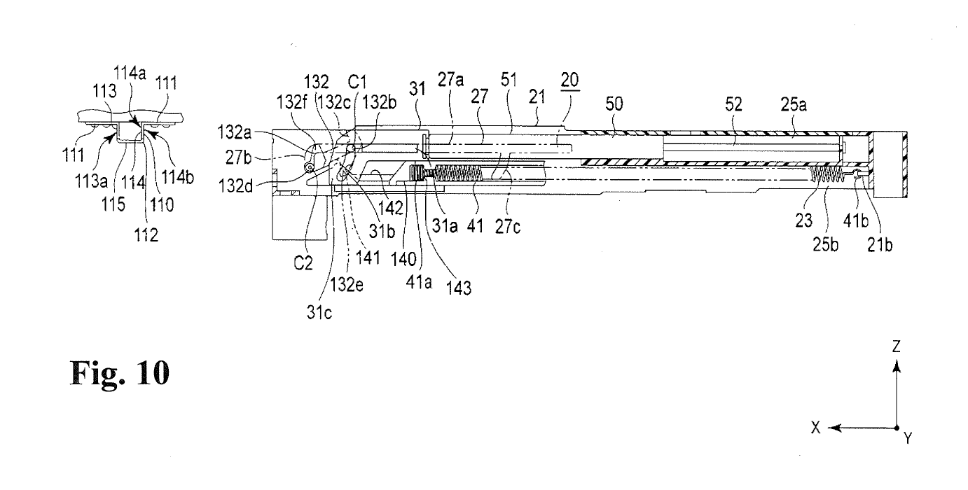

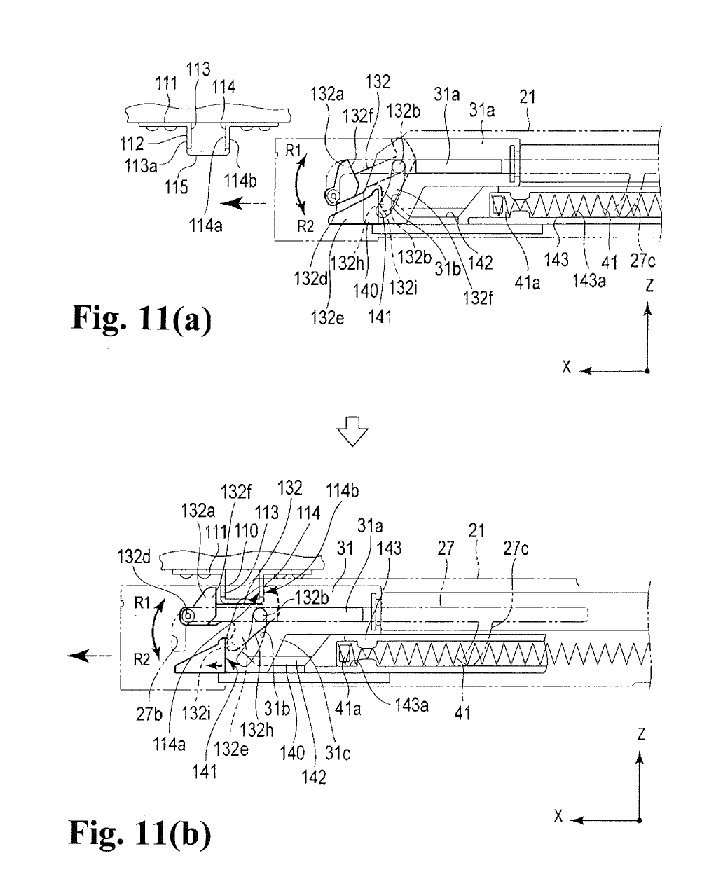

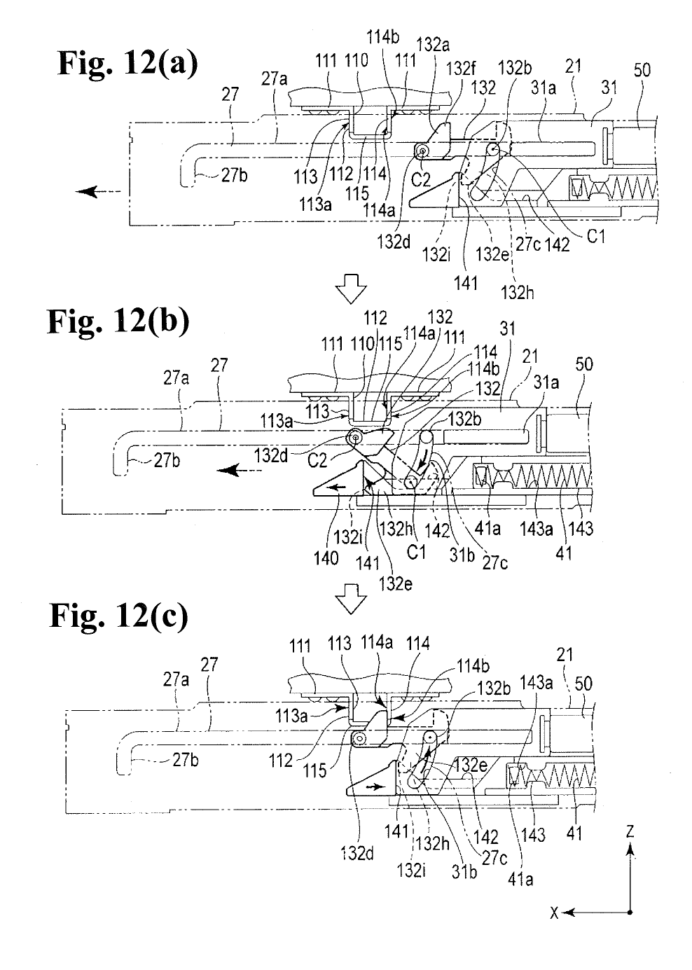

A movable body assisting apparatus 2 according to a second embodiment is described below while referring to FIGS. 9 through 12c. FIG. 9 is a perspective view illustrating a part of the assisting apparatus 2, and a cam 132, a guide member 140, and a striker 110 are illustrated. FIG. 10 is a side view illustrating the assisting apparatus partially cut away in cross section. FIGS. 11a and 11b are explanatory diagrams illustrating normal movement, and FIGS. 12a, 12b, and 12c are explanatory diagrams illustrating movement when returning from malfunction.

The striker 110 of the assisting apparatus 2 has a structure in which a plate-form member is formed bent. In the assisting apparatus 2, a guide coupling part 132e is provided on a cam 132, and a guide member 140 is interposed and connected between a tension coil spring 41 and the cam 132, so that the movement of the tension coil spring 41 is restricted. The rest of the configuration and the operation are the same as in the movable body assisting apparatus according to the first embodiment, and therefore common descriptions are omitted.

The striker 110 is shaped by bending one plate-form metal sheet by sheet metal processing, or the like, and has integrally a plate-form installation member 111 attached to the upper frame F1, and a coupling projection 112 projecting downward from the upper frame F1. The installation member 111 has a pair of flat plate-form bases 111a, and hole parts 111b provided on the bases 111a and used for fixing the bases 111a to the upper frame F1 by wood screws or other fastening members into the upper frame F1.

The coupling projection 112 forms an angle-bracket form open in side view from the Y direction. The coupling projection 112 has a plate-form first coupling part 113 continuing with one base 111a; a plate-form second coupling part 114 continuing with the other base 111a; and a connection part 115 making the first coupling part 113 and the second coupling part 114 continuous.

The first coupling part 113 is disposed on the side (first direction side) of the coupling projection 12 facing the position at the end of movement of the sliding door M, and the second coupling part 114 is disposed on the other side (second direction side). The surface of the first coupling part 113 on the side facing the position at the end of movement forms a first coupling surface 113a for coupling with the hook part 132f of the latch 22 when normal. The end surface of the second coupling part 114 on the side facing the position at the end of movement forms a second coupling surface 114a for coupling with the hook part 132f when returning from malfunction. Also, the surface of the second coupling part 114 on the second direction side on the opposite side to the second coupling surface 114a forms a pressing surface 114b for pressing the pressed part 132c.

The connection part 115 is a plate-form member placed spanning between the lower end of the first coupling part 113 and the lower end of the second coupling part 114, and the width in the Y direction is formed smaller than the width in the Y direction of the first coupling part 113 and the second coupling part 114. The dimensions are set so that a pair of hook parts 132f of a latch 22 to be described become capable of advancing into spaces on both sides in the Y direction of the connection part 115 when returning from malfunction.

The latch 22 of the assisting apparatus 2 has a latch base 31 and a cam part 132 connected to be capable of rotation on the leading end part of the latch base 31, and is supported to be capable of movement between the side walls 21a and 21a inside the housing 21. The cam part 132 is connected to a tension coil spring 41 by way of a rail member 140.

The cam part 132 has an axial center C1 following the Y direction, and a pair of first shaft parts 132b projecting in the Y direction, just like the cam 32 according to the abovementioned first mode of working.

The first shaft part 132b is inserted through the slit 27 and the groove 31b and is coupled to be capable of rotation and to be capable of moving inside the slit 27. When returning from malfunction, the cam part 132 rocks while rotating in the R1 direction around the second shaft part 32d while the first shaft part 132b moves downward along the retreat path 27c.

The cam part 132 is provided to be capable of rotation in a first rotational direction R1 and in an opposite second rotational direction R2 around the first shaft part 132b. The cam part 132 is configured with a catcher 132a, a pressed part 132c, an impelled part 132e, and a pair of second shaft parts 132d, in this order clockwise on the outer perimeter thereof.

The catcher 132 is provided on the leading end side of the cam 132, and has a pair of hook parts 132f projecting in the R1 direction. The hook parts 132f are provided respectively on both sides in the Y direction, and include a triangular plate-form member projecting in the first rotational direction R1.

The pressed part 132c is formed to project upward on the upper part of the cam part 132, and contacts with the pressing surface 114b of the striker 10 and is pressed in the drawing-in direction by movement of the movable body.

The pair of second shaft parts 132d is formed on the catcher 132a, has an axial center C2 following the Y direction, is formed to project in the Y direction, and is coupled to be capable of moving inside the slit 27.

The impelled part 132e is normally urged to the drawn-in position by the tension coil spring 41 intermittently with a guide member 140 as an auxiliary moving body being interposed. The impelled part 132e is configured with a pair of guide pieces 132h formed to project downward in the R1 direction and forward from a position further rearward from the second shaft part 132d of the cam 132. A guide rail 141 of the guide member 140 is made capable of advancing between these guide pieces 132h. The leading end part 132i of the guide piece 132h contacts with the coupling wall 141 of the guide member 140, and the forward and rearward position of the guide member 140 are restricted in accordance with the movement of the latch 22.

The guide member 140 is supported to be capable of moving along the sliding direction between the side walls 21a and 21a inside the housing 21. A guide rail 142 extending along the X direction is placed upright on the lower part of the guide member 140. The guide rail 142 is formed in the center position in the Y direction of the guide member 140, and inclines at the front portion so that the height of the front side is raised. The guide rail 142 is held between the guide pieces 132h, and the guide member 140 and the cam 142 are coupled to be capable of moving in a straight line. A coupling wall 141 forming a ZY plane is formed upright on the front end of the guide rail 142. Both coupling walls 141 are formed on both sides in the Y direction of the guide rail 142, and contact with the leading end parts 132i of both guide pieces 132h.

A connection part 143 hooked and connected with one end 41a of the tension coil spring 41 is formed on the other end of the guide member 140. The connection part 143, for example, has a receiving part 143a where the end part of the tension coil spring 41 is received and hooked. The guide member 140 is normally drawn in the drawing-in direction by the tension coil spring 41, so that the leading end part 132i and the coupling wall 141 are normally in contact.

When the leading end part 132i of the impelled part 132e moves in the vertical and forward-backward directions accompanying rotational and linear movements in the R1 and R2 directions of the cam 132, the guide member 140 being pressed by the leading end part 132i moves forward and backward. Specifically, the forward-backward and vertical movements of the leading end part 132i are changed into only the forward-backward direction (X direction).

The tension coil spring 41 is disposed in the lower part of the housing 21 so that the axial direction follows the sliding direction just as in the first mode of working. One end of the tension coil spring 41 is hooked to the guide member 140 on the lower part of the latch 22, and the other end is connected to the connection part 21b of the housing 21. The tension coil spring 41 has a function of urging the latch 22 in the standby state in the drawing-in direction with the guide member 140 interposed and thereby hanging and holding the latch on the standby path 27b, a function of urging and forcibly moving the latch 22 on the main guide path 27a in the drawing-in direction, and a function of urging the latch 22 in the R2 direction.

The movement of the assisting apparatus is described while referring to FIGS. 11a and 11b and FIGS. 12a, 12b, and 12c. An operator moves the sliding door M toward the doorstop F1, being the position at the end of movement on the left side, from the first state illustrated in FIG. 11a, whereby the sliding door M reaches a first prescribed position and the latch 22 contacts with the striker 110. Then, as illustrated in FIG. 11b, the striker 110 pushes the pressed part 132 in rearward, whereby the cam part 132 rotates in the R1 direction centered on the first shaft part 132b.

By this rotation, the hook part 132f on the leading end of the cam part 132 couples to the striker 110, the striker 110 is captured by the latch 22, and at the same time, the second shaft part 132, being down, moves upward and reaches a position to enter into the main guide path 27a, holding to the standby path 27b is released, and it comes to a state in which movement is possible following the sliding axis, being the center line of the main guide path 27a. Also, the latch 22 moves relatively rightward against the housing 21 and the sliding door M and is moved relatively up to the drawn-in position by the return force of the tension coil spring 41. The sliding door M and the housing 21 are forcibly moved relatively to one end side in the sliding direction against the support body F and the striker 110 accompanying this movement.

Here, the leading end part 132i moves relatively forward and downward against the housing 21 accompanying the rotational movement in the R1 direction of the cam part 132. At this time, the guide member 140 presses the coupling wall 141 forward while the leading end part 132i slides downward against the coupling wall 141 while being in contact with the coupling wall 141. Also, the guide member 140, being capable of moving in the forward-backward direction, moves forward while stretching the tension coil spring 41. At this time, because the other end side of the tension coil spring 41 moves forward and backward in the sliding direction but does not move in the vertical direction, the position in the Z direction of the tension coil spring 41 is kept fixed. In the second movement from the second state to the first state, the movement is in the order of FIGS. 11b and 11a, being the opposite of the abovementioned first movement.

In the third movement to return from a malfunctioning state as illustrated in FIGS. 12a, 12b, and 12c, when the sliding door M is moved in the first direction against the support body from the third state in which the latch 22 is in the drawn-in position in a state in which the coupling with the striker 110 was released as illustrated in FIG. 12a, a part (here, hook part 1321) of the cam 132b contacts with the striker 110 and is pressed rearward. By this pressing, as illustrated in FIG. 12b, the cam part 132 rocks while rotating in the R1 direction centered on the second shaft part 132d while the first shaft part 132b moves downward along the groove part 31b and the retreat path 127c.

By this rocking, the upper end of the hook part 132f of the catcher 132a retreats further downward from the second state, whereby the striker 110 becomes capable of riding over the hook part 132f, moves along the X direction, and thereby becomes capable of moving relatively up to the position to be capable of coupling to the latch 22.

When the cam 132 rocks while rotating in the R1 direction while the first shaft part 132b moves downward along the retreat path 127c, the leading end part 132i moves forward and downward against the housing 21. At this time, the leading end part 132i presses the coupling wall 141 forward in the sliding direction while sliding in the Z direction against the coupling wall 141 while being in contact with the coupling wall 141. Also, the guide member 140 moves forward while stretching the tension coil spring 41. At this time, because the end part 41a of the tension coil spring 41 moves forward and backward in the sliding direction but does not move in the vertical direction, the position in the Z direction of the tension coil spring 41 is kept fixed.

When the second coupling part 114 of the striker 110 rides over the hook part 132f, the cam part 132 rotates in the R2 direction by the return force of the tension coil spring 41 just as in the abovementioned first embodiment, and as illustrated in FIG. 12c, the hook parts 132f advance into both sides of the connection part 115 and interfere with the second coupling surface 114a, whereby the latch 22 is coupled with the striker 110. When the sliding door M is moved in the second direction (direction moving away from the position at the end of movement) in this coupled state, the movement follows the main guide path 27a in the state in which the striker 110 is captured by the latch 22. Also, when the sliding door reaches the prescribed position, the coupling between the striker 110 and the latch 22 is released, and the first state in which the latch 22 is held in the standby position is restored.

The same effect as in the abovementioned first embodiment is obtained also in the present embodiment. Furthermore, in the assisting apparatus 2 according to the second embodiment, the movement of the tension coil spring 41 in the vertical direction is restricted and is changed into only movement of expansion and contraction following the sliding direction, whereby the movable range of the tension coil spring 41 can be restricted and the apparatus can be made compact. Specifically, in the case in which the tension coil spring 41 is directly connected to the latch 22, the tension coil spring is displaced in the Z direction accompanying rotation of the latch 22, but in the present mode of working, the rotational movement of the latch 22 is changed to movement in the sliding direction by contacting the guide member 140 to the coupling wall 141, whereby the displacement of the tension coil spring 41 is only in the sliding direction (X direction), and the position in the Z direction can be kept fixed. Accordingly, the space for receiving the tension coil spring 41 in the housing can be kept smaller, and the entire assisting apparatus 2 can be made compact.

The present invention is not limited to the aforementioned embodiments, and various modifications can be carried out within a scope that does not deviate from the main point of the present invention. Also, the specific configurations or materials of each part, or the like, are not limited to those illustrated in the abovementioned odes of working, and can be suitably changed.

For example in the abovementioned embodiments, a case in which the assisting unit 20 is provided on the side of the sliding door M as the movable body and the striker 10 is provided on the side of the door frame F as the support body was illustrated as an example, but the present invention is not limited to this, and the striker 10 may be provided on the side of the movable body and the assisting unit 20 may be provided on the side of the support body. In the abovementioned first and second embodiments, strikers 10 and 110 having different structures were illustrated as examples, but the present invention is not limited to this, and, for example, various combinations are possible.

Also, in the abovementioned embodiments, a case in which the movable body is a sliding door M is illustrated as an example, but the present invention can be applied also to hanging doors, ascending-descending-type sliding doors, and other movable bodies.

In the present embodiments, a case in which separate coupling recesses 12b and 12d are provided and the hook parts 32f couple in different positions for use when normal and when returning from malfunction are illustrated as examples, but the coupling may be done in the same position for use when normal and when returning from malfunction. In this case as well, retreating and coupling again become possible in the same manner as in the abovementioned embodiments by rocking in the retreating direction.

In the abovementioned embodiments, the description was given focusing on one sliding door M, but the present invention can be applied also in the case in which two or more of substantially the same kinds of sliding doors M and assisting units 20 are provided.

Furthermore, the present invention can be realized also omitting some of the configurative elements of the abovementioned modes of working.

The entire contents of the specifications, claims, drawings, and abstracts of Japanese Patent Application No. 2011-055894 filed on Mar. 14, 2011 and of Japanese Patent Application No. 2011-238531 filed on Oct. 31, 2011 are incorporated by reference herein as a disclosure of the specification of the present invention.

1. A movable body assisting apparatus, comprising:
a received body provided on either one of a support body and a movable body that moves relatively against said support body; and
a base body provided on the other of the support body and the movable body, a contact body provided to be capable of coupling and uncoupling with said received body, to be capable of moving along a course of movement from a first position to a second position on said base body, and to be capable of rocking while moving in a direction retreating from said course of movement, and an urging mechanism for urging said contact body.

2. The movable body assisting apparatus according to claim 1, wherein
the base body includes a slit having continuously a main guide path formed along said course of movement from said first position to said second position and a retreat path bending from said second position on said main guide path; and
said contact body has a first shaft part and a second shaft part for coupling to said slit, is made capable of coupling with said received body by rotating in a first rotational direction around said first shaft part in said first position, is made capable of releasing said coupling by rotating in a second rotational direction opposite the first rotational direction around said first shaft part, and rocks while rotating around said second shaft part on said main guide path with said first shaft part moving along said retreat path when retreating from said course of movement.

3. The movable body assisting apparatus according to claim 2, further comprising:
a damping mechanism for applying a resistance force to movement of said contact body;
wherein in a first movement, said movable body moves in the first direction on the support body from a first state in which said contact body is held in said first position, whereby holding in said first position is released and said contact body and said received body move in a coupled state with said contact body being urged in the second direction by said urging mechanism, whereby said movable body is forcibly moved on said support body, to be a second state in which said contact body and said received body are disposed in the coupled state in said second position;
in a second movement, said contact body and said received body move toward the first position while said movable body moves toward said second direction on said support body from a state in which said contact body and said received body are disposed in a coupled state in said second position, and upon reaching a prescribed position, the coupling between said contact body and said received body is released to become said first state in which said contact body is held in said first position; and
in a third movement, said movable body moves in the first direction on said support body from a third state in which said contact body is in said second position in a state in which the coupling between said contact body and said received body is released, said contact body in said second position then temporarily retreats from said course of movement, during which time said received body moves relatively in the second direction up to a position to be capable of coupling with said contact body and couples with said contact body, said contact body and said received body move toward the first position in the coupled state while said movable body moves in the first direction, and upon reaching a prescribed position, the coupling between said contact body and said received body is released, and said first state in which said contact body is held in said first position is restored.

4. The movable body assisting apparatus according to claim 3, wherein
said slit has integrally a standby path bending from said first position on said main guide path;
said contact body has a cam part that rotates around a first shaft part that is capable of moving inside said slit, and said cam part has a pressed part that is pressed on contact with said received body by movement of said movable body, a catcher that is capable of coupling and uncoupling with said received body by said rotation, a second shaft part that is capable of moving inside said slit, and an impelled part that is drawn in said second direction by said urging mechanism;
in said first movement, said pressed part is pressed by the received body and said cam part rotates in the first rotational direction by movement of said movable body in said first direction, whereby said received body is captured by said catcher, and said second shaft part moves at the same time on said main path from said standby path;
in said second movement, said pressed part is moved away from the received body and said cam part rotates in said second rotational direction by movement of said movable body in said second direction, whereby said received body is released by said catcher, and said second shaft part moves at the same time on said main path from said standby path; and
in said third movement, said pressed part is pressed by the received body by movement of said movable body in said first direction, whereby said cam part temporarily rotates in said first rotational direction around said second shaft while said first shaft part moves on said retreat path.

5. The movable body assisting apparatus according to claim 4, wherein said received body has a first coupling part to which said catcher couples in said first and second movements, and a second coupling part to which said catcher couples in said third movement, and said second coupling part is disposed further toward a leading end side from said first coupling part.

6. The movable body assisting apparatus according to claim 2, wherein said urging mechanism includes a tension coil spring having one end connected to said contact body and the other end connected to said housing or to the other of said movable body and support body; and has:
a function of urging said contact body in said standby state in said second direction and thereby hanging and holding the contact body on said standby path;
a function of urging and moving said contact body on said main guide path in said second direction; and
a function of urging said contact body in the second rotational direction.

7. The movable body assisting apparatus according to claim 1, wherein said damping mechanism is a piston damper having a cylinder and a piston rod, one of which is connected to said contact body and the other is connected to said base body or to the other of said movable body and support body, and a resistance force of a fluid inside the cylinder is applied to pushing and pulling movements of the piston rod into and out from said cylinder.

8. The movable body assisting apparatus according to claim 4, wherein said impelled part of said cam and said urging mechanism are coupled by a guide member for restricting a position of said urging mechanism.

9. The movable body assisting apparatus according to claim 8, wherein
said urging mechanism includes a tension coil spring having one end connected to said guide member and the other end connected to said base body or to the other of said movable body and support body; and
said guide member contacts with said impelled part and is urged in said first direction by said urging mechanism, and is configured to be capable of moving relatively along said first direction and said second direction against said base body or against the other of said movable body and support body accompanying movement of said cam.

10. The movable body assisting apparatus according to claim 9, wherein
said guide member has a coupling wall for contacting and coupling with said impelled part, and a connecting part connected to said urging mechanism; and
said impelled part presses said coupling wall while rocking along said coupling wall of said guide member, whereby displacement of said impelled part accompanying rotation of said cam is changed to linear movement and is relayed to said urging mechanism.

11. The movable body assisting apparatus according to claim 10, wherein
said guide member has a guide rail for coupling with said impelled part and said coupling wall is provided on a front end part;
said impelled part has a guide piece projecting in said first rotational direction from a position further rearward from said second shaft body on said cam; and
the leading end part of said guide piece contacts with said coupling wall, whereby said impelled part of said cam is urged in the first direction by said urging mechanism through said guide member.
